(19) United States
(12) Patent Application Publication
(10) Pub. No.: US 2025/0376243 A1
(43) Pub. Date: Dec. 11, 2025

(54) Drive Assembly of an Electric Bicycle

(71) Applicant: Robert Bosch GmbH, Stuttgart (DE)

(72) Inventors: Christoph Zimmermann, Nehren (DE); Sigmund Braun, Kusterdingen (DE)

(21) Appl. No.: 19/229,845

(22) Filed: Jun. 5, 2025

(30) Foreign Application Priority Data
Jun. 7, 2024 (DE) 10 2024 205 289.2

(51) Int. Cl. B62M 6/55

(52) U.S. Cl. CPC B62M 6/55

(57) ABSTRACT

A drive assembly of an electric bicycle includes (i) an output element which is configured to transmit a motor torque, (ii) an output shaft, (iii) a first freewheel, and (iv) a second freewheel. The first freewheel and the second freewheel are disposed on the output shaft. The first freewheel and the second freewheel are disposed coaxially and at least partially overlapping in the axial direction.

This application claims priority under 35 U.S.C. § 119 to application no. DE 10 2024 205 289.2, filed on Jun. 7, 2024 in Germany, the disclosure of which is incorporated herein by reference in its entirety

### BACKGROUND

The present disclosure relates to a drive assembly of an electric bicycle, as well as to an electric bicycle.

In electric bikes, freewheels are known which are configured so as to interrupt a connection between a driven output element shaft and, for instance, a motor gear unit which is connected with the drive motor, if the driven output element runs faster than an output of the motor with respect to the forward direction of rotation, i.e., in the direction of rotation that causes the vehicle to be driven in the forward direction of travel. Freewheels are also known, which are disposed between a crankshaft, which can be actuated by a rider's pedal torque, and a chain ring to separate the cranks and the rider from the powertrain in the freewheel direction. Often, such freewheels are disposed in the area of bottom brackets of the electric bicycle.

### SUMMARY

In contrast, the drive assembly according to the disclosure with the features set forth below is characterized by an advantageous compact design, which requires a particularly small amount of design space with simple manufacturing and few components. According to the present disclosure, this is achieved by a drive assembly of an electric bicycle comprising an output element, an output shaft, a first freewheel, and a second freewheel. In particular, the output element is adapted to transmit a motor torque. That is, preferably, the output element may be driven by a motor torque, and in particular, may continue to transmit that motor torque further. The first freewheel and the second freewheel are disposed on the output shaft. The first freewheel and the second freewheel are disposed coaxially to one another. In addition, the first freewheel and the second freewheel are disposed at least partially overlapping in the axial direction.

In particular, the output element is configured to be driven by the motor torque, for example indirectly via a transmission.

Preferably, the output shaft may be configured to be connectable to a further drive train of the vehicle, for example, via a chain wheel and preferably a chain or alternative transfer element. That is, preferably, the output shaft may be disposed and configured so that it can be driven by the total torque of the system, that is, the sum of the pedal torque and the motor torque.

Particularly preferably, the output element may be a gear of a transmission of the drive assembly, such as the final gear of a transmission of the drive assembly.

In particular, an element is considered a freewheel, which in a lockout configuration allows torque transmission between two components of the drive assembly, and in a freewheel configuration prevents torque transmission between the two components, and thus in particular allows free relative rotation of the two components.

In particular, it is considered to be partially overlapping if at least sub-areas of each of the two freewheels lie in a common sectional plane that is orthogonal to the common axis of the two freewheels.

Preferably, the two freewheels overlap by at least 50% of the axial length of one of the two freewheels in the axial direction. Further preferably, one of the two freewheels may be completely overlapped by the other freewheel in the axial direction.

In other words, a drive assembly of an electric bicycle is provided, which comprises two freewheels that at least partially overlap axially, in particular in an axial sectional plane. The two freewheels are arranged coaxially with each other. That is, the components, whose relative rotation locks and releases the freewheels with respect to each other, may rotate about the common axis, at least in the corresponding freewheel configuration.

The drive assembly offers the advantage that a particularly simple and inexpensive design can be provided, which allows for particularly compact dimensions of the drive assembly. In particular, a particularly compact geometry of the drive assembly in the axial direction can be provided. This can make it possible for cranks of the electric bicycle, which can be connected to the drive assembly, to be disposed particularly close to each other along the axial direction. In particular, a low so-called Q-factor can thereby be provided. This allows for particularly comfortable and ergonomically advantageous geometries of the electric bicycle in the area of the bottom brackets.

Preferred further modifications of the disclosure are set forth below.

Preferably, the second freewheel is a trapped roller freewheel. That is to say, the second freewheel has in particular a plurality of trapped rollers. Thus, a reliable freewheeling and lockout function can be provided with simple and inexpensive manufacturing.

Particularly preferably, the first freewheel is a bi-directional freewheel. That means that the first freewheel may lock and release with respect to both directions of rotation. Preferably, this can be done by way of actively controllable actuation or alternatively by way of frictional forces. As a result, a particularly flexible operation of the drive assembly can be provided.

Preferably, the first freewheel is configured to additionally provide a bearing function, in particular in the freewheel direction. That means that, in addition to locking and releasing the torque transfer, the first freewheel may provide a bearing function, particularly at least during rotation in the freewheel direction. In this way, a particularly simple, inexpensive and compact design of the drive assembly can be provided, since several functions can be particularly advantageously integrated into the first freewheel.

Further preferably, the first freewheel is disposed between the output element and the output shaft and is configured as a motor freewheel. In particular, the first freewheel thus permits torque transfer from the output element towards the output shaft in the locking direction. That is, in the locked state, a torque, for example, a motor torque, from a motor that may be provided on the output element is transmitted from the output element towards the output shaft via the first freewheel. Preferably, torque transmission in a freewheel direction opposite the locking direction is prevented by the first freewheel, that is, in this case, the freewheel will open. In this way, it may be easily and reliably ensured that a motor torque may be provided to the output shaft, wherein it may prevent a torque from being transmitted towards the motor.

Preferably, the drive assembly further comprises a crankshaft, wherein the second freewheel is disposed between the crankshaft and the output shaft. The second freewheel is configured as a rider freewheel. In particular, the second freewheel allows torque transmission from the crankshaft towards the output shaft in the locking direction. That is to say, in the locked state, the second freewheel causes torque transmission, for example, of the pedal torque that may be applied by a rider of the electric bicycle, from the crankshaft to the output shaft. In particular, the second freewheel may prevent torque transmission between the crankshaft and the output shaft in the freewheeling direction and/or in the open state. Thus, it can be made possible for the rider to decouple from the drivetrain in the freewheeling state in a simple and reliable manner, wherein in the locking direction, the rider can always apply a pedal torque to drive the electric bicycle.

Preferably, the drive assembly further comprises a freewheel carrier that is connected to the crankshaft in a rotationally fixed manner. For example, the freewheel carrier may be connected to the crankshaft in a rotationally fixed manner by way of a positive-locking and/or material-locking and/or friction-locking connection. Alternatively, the freewheel carrier and the crankshaft may be configured together as an integral component. In particular, the freewheel carrier may hold a freewheel or both freewheels. In other words, the freewheel carrier is formed as part of at least one of the two freewheels, for example forming a corresponding inner ring and/or outer ring. This can provide a simple and cost-effective design for the drive assembly at a low weight.

Preferably, the second freewheel is disposed between the freewheel carrier and the output shaft, in particular directly, preferably in the radial direction. This allows for a particularly simple and inexpensive design to be provided with a few components, which are particularly compact in the axial direction.

Preferably, the freewheel carrier and the output shaft are rotatably supported relative to one another by way of a bearing. In particular, the bearing is a needle bearing. Preferably, the needle bearing is located radially directly between a sub-area of the freewheel carrier and a sub-area of the output shaft. As a result, a particularly compact design can be enabled for the drive assembly. In particular, this provides more design space for the freewheel carrier and the output shaft, which allows for a design that is optimally adapted to the applicable mechanical requirements.

Further preferably, the drive assembly comprises a further needle bearing between the output shaft and the crankshaft for a particularly compact design.

Preferably, the drive assembly further comprises an axial bearing element, which is in particular configured as an axial bearing washer, also known as a thrust washer. The axial bearing element is disposed in the axial direction between the freewheel carrier and the output shaft. Preferably, a further axial bearing element is additionally disposed in the axial direction between the freewheel carrier and the output shaft. In this way, axial support of forces can be provided in a simple and cost-efficient manner, thereby enabling a particularly robust and durable construction.

Particularly preferably, the freewheel carrier is connected to the crankshaft by way of splines. In particular, the spline is configured such that there is radial clearance between the freewheel carrier and the crankshaft. This allows the freewheel carrier and the crankshaft to be connected in a rotationally fixed manner in a simple and cost-efficient way, wherein a certain compensation of tolerances or elongations or relative movements in the radial direction is possible.

Further preferably, the first freewheel is radially disposed within the second freewheel. In other words, the second freewheel is disposed on a larger diameter than the first freewheel. For example, a simple and inexpensive design may be provided in which the second freewheel may be radially disposed directly between the freewheel carrier and the output element, which may be configured as a gear with a keying on the radially outer side, for example. A portion of the output shaft may be advantageously arranged between the two freewheels, for example.

Alternatively, preferably, the second freewheel is radially disposed within the first freewheel. In other words, the first freewheel is disposed on a larger diameter than the second freewheel. Thereby, due to the larger diameter of the first freewheel, a greater maximum torque may be transmitted by this freewheel. In particular, if the first freewheel is configured as a rider's freewheel, a high pedal torque can thus be reliably and robustly transmitted by it.

Particularly preferably, the drive assembly further comprises a bearing which is formed coaxially with the first freewheel and the second freewheel respectively at least partially overlapping in the axial direction. Preferably, the bearing completely overlaps axially with at least one of the two freewheels. The bearing can in particular be configured as a ball bearing. Preferably, the bearing is disposed between the freewheel carrier and the output shaft to provide relative support of these two elements. By additional integration of the bearing in an axially overlapping manner with the freewheels, a particularly compact geometry of the drive assembly in the axial direction can be enabled.

Preferably, the drive assembly furthermore comprises a motor and a transmission. In particular, the motor is an electric motor, and it in particular is adapted to provide a motor torque as a function of a pedal torque of the rider of the electric bicycle. The transmission is disposed between the motor and the two freewheels during this process. In particular, the output element is a part of the transmission. For example, the output element may be the final gear of the transmission. Preferably, the transmission may be configured as a multi-stage spur gear.

Preferably, the motor comprises a motor shaft at which the motor torque may be provided. The motor shaft is arranged coaxially to the output shaft. In particular, the entire motor is disposed coaxially to the output shaft. In other words, a coaxial drive is thus provided. For example, the transmission may comprise an intermediate shaft, wherein the motor torque may be transferred from the motor shaft to the intermediate shaft via a keying, and from the intermediate shaft to the output shaft via a further keying. A particularly compact and inexpensive drive assembly can thus be provided, wherein the axial design space adjacent to the motor can be kept particularly small by the axially overlapping freewheels, in order to enable a particularly small overall axial size of the drive assembly.

Further preferably, the motor comprises a motor shaft at which the motor torque can be provided, wherein the motor shaft is disposed parallel to the output shaft and at a predetermined distance from the output shaft. In other words, a parallel drive is thus provided. In particular, the motor is disposed in the radial direction adjacent to the output shaft. An alternative design and geometry of the drive assembly can thus be provided, which is simple and inexpensive to manufacture and has particularly compact dimensions in the axial direction.

Furthermore, the disclosure leads to an electric bicycle comprising the described drive assembly.

### BRIEF DESCRIPTION OF THE DRAWINGS

Exemplary embodiments of the disclosure are explained in detail below with reference to the accompanying drawings.

FIG. 1 is a simplified schematic view of an electric bicycle with a drive assembly according to a first exemplary embodiment of the disclosure,

FIG. 2 is a detail sectional view of the drive assembly of the first exemplary embodiment,

FIG. 3 is a detailed side view of the drive assembly of the first exemplary embodiment,

FIG. 4 is a detailed sectional view of a drive assembly according to a second exemplary embodiment of the disclosure, and

FIG. 5 is a detailed sectional view of a drive assembly according to a third exemplary embodiment of the disclosure,

FIG. 6 is a detailed sectional view of a drive assembly according to a fourth exemplary embodiment of the disclosure,

FIG. 7 is a perspective view of a detail of the drive assembly of FIG. 6, and

FIG. 8 is a perspective view of a detail of a drive assembly according to a fifth exemplary embodiment of the disclosure.

### DETAILED DESCRIPTION

Preferably, all identical components, elements, and/or units are provided with the same reference symbols in all figures.

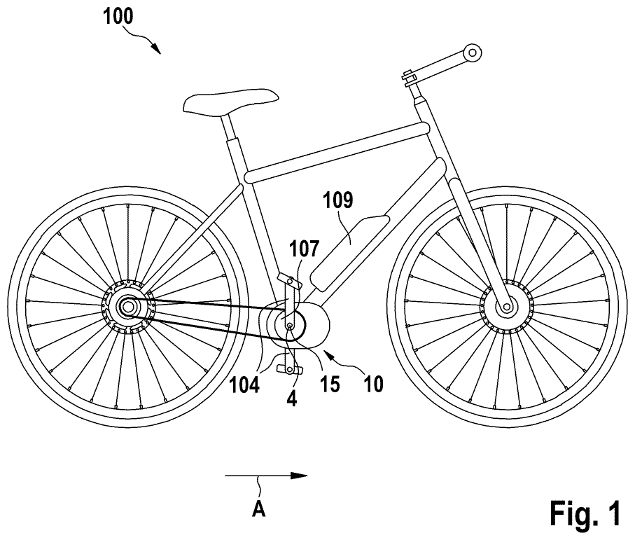

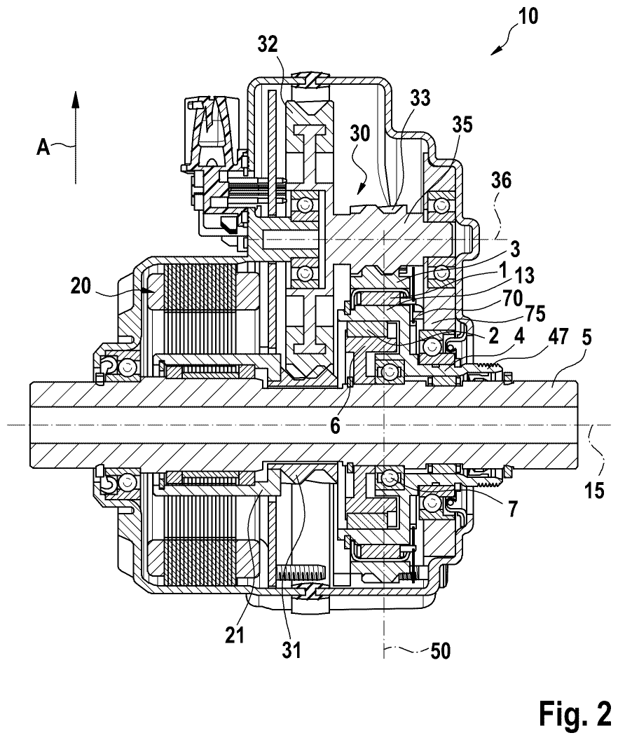

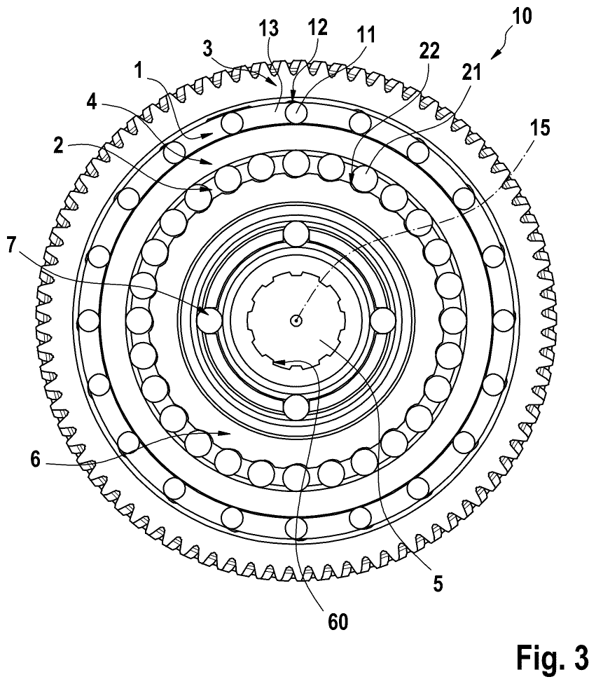

FIG. 1 shows a simplified schematic view of an electric bicycle 100 with a drive assembly 10 according to a first exemplary embodiment of the disclosure. Details regarding the drive assembly 10 of the first exemplary embodiment are shown in FIGS. 2 and 3.

The drive assembly 10 comprises a motor 20, which is in particular an electric motor. The motor 20 can be supplied with electrical energy by way of an electrical energy store 109 of the electric bicycle 100.

The drive unit 10 is disposed in the region of a bottom bracket of the electric bicycle 100. A motor torque generated by the motor 20 can be used to provide motorized support for the pedal force generated by the muscle power of a rider of the electric bicycle 100.

In addition to the motor 20, the drive assembly 10 comprises a transmission 30, a crankshaft 5, and an output shaft 4 (cf. in particular FIG. 2).

The crankshaft 5 extends along a crank axis 15. The output shaft 4 is disposed coaxially to the crankshaft 5. In detail, the crankshaft 5 extends through the output shaft 4, wherein the crankshaft 5 and the output shaft 4 are rotatably supported relative to one another, among other things by way of a bearing 7.

The output shaft 4 comprises an output interface 47. An output element 107, which is in particular configured as a chain ring (cf. FIG. 1), can be connected with the output interface 47. The output element 107 can transmit torque to a rear wheel of the electric bicycle 100 via a transmission element, in particular a bicycle chain.

The crankshaft 5 can in particular be connected with cranks 104 (cf. FIG. 1) in a rotationally fixed manner. The rider of the electric bicycle 100 may generate a pedal torque on the crankshaft 5 via the cranks 104.

In the drive assembly 10, the motor torque generated by the motor 20 and/or the pedal torque generated at the crankshaft 5 by the rider may be transmitted to the output shaft 4 to provide an output torque at the output element 47.

To transmit motor torque, the drive assembly 10 comprises a transmission 30. The motor 20 comprises a motor shaft 21 that is connected to a motor spline 31 in a rotationally fixed manner. The motor torque is transferred by the motor spline 31 to a second gear 32, which is connected to an intermediate shaft 35 in a rotationally fixed manner.

The intermediate shaft 35 is rotatable about an intermediate shaft axis 36, which is disposed parallel to the crank axis 15 and at a distance from the crank axis 15.

The intermediate shaft 35 also comprises a third gear 33, which is connected to the intermediate shaft 35 in a rotationally fixed manner. From the third gear, the torque is further transferred to an output element 3, which is configured as a gear that is rotatable about the crank axis 15.

A first freewheel 1 is disposed between the output element 3 and the output shaft 4. Depending on the freewheel configuration of the first freewheel 1, it may permit torque transmission from the output element 3 to the output shaft 4, or alternatively, may prevent said transmission, i.e., permit a relative free rotation.

The first freewheel 1 is configured as a bi-directional freewheel. That means that the first freewheel 1 may open in both relative rotation directions of the output element 3 and the output shaft 4, that is, permit free rotation without torque transmission. This can be done by, for example, selectively controlled actuation of a freewheel cage 13 of the first freewheel 1 (cf. FIG. 3).

The freewheel cage 13 is provided to ensure circumferentially predetermined distances of the trapped rollers 11 of the first freewheel 1. In addition, the freewheel cage 13 may, for example in certain operating states, selectively cause movement of the trapped rollers 11 such that they are brought into a freewheel configuration in which the first freewheel 1 is opened.

Movement of the freewheel cage 13 to provide controlled actuation of the freewheel function, that is, bidirectionality, through corresponding movement of the clamping rollers 11, can be accomplished by way of a friction element 70, which is connected to the freewheel cage 13 in a rotationally fixed manner.

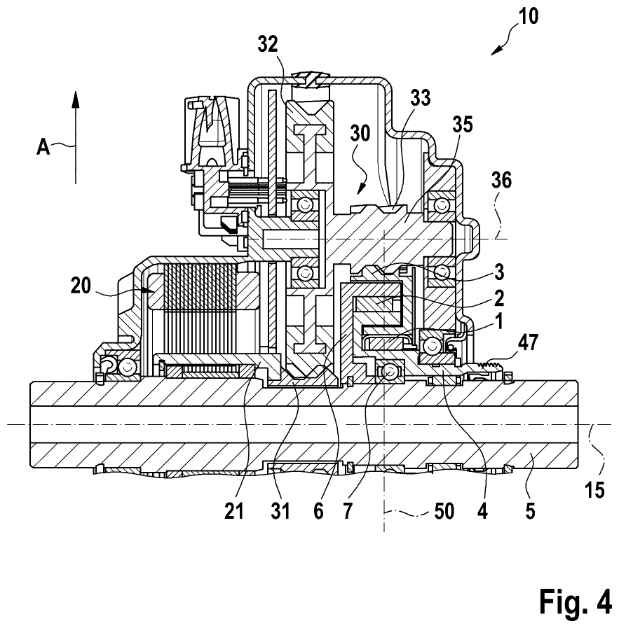

FIG. 4 shows the connection of the freewheel cage 13 to the sheet-shaped friction element 70. The friction element 70 can extend in the radial direction.

The friction element 70 is configured as a friction ring. A plurality of spring elements are distributed around the perimeter, in particular on a fixed housing part 75, each of which pushes against the friction element 70 in the axial direction by way of a spring force. This creates a friction torque between the housing part 75 and, via the friction element 70, the freewheel cage 13, whereby the freewheel cage 13 is rotated in a relative manner in the circumferential direction in order to move the trapped rollers 11 and thus block or release the first freewheel 1.

The first freewheel 1 is also configured to provide a bearing function in the freewheeling direction, that is, in the open state. That is to say, with the first freewheel 1 open, the first freewheel 1 allows a free relative rotation of the output element 3 and the output shaft 4 to each other and also results in a bearing function, comparable to a sliding bearing.

In the locking direction, that is to say with the first freewheel 1 locked, a torque may be transmitted from the output element 3 to the output shaft 4 via the first freewheel 1.

In addition, the drive assembly 10 comprises a freewheel carrier 6 and a second freewheel 2. The freewheel carrier 6 is connected to the crankshaft 5 in a rotationally fixed manner, for example by way of a splined shaft connection 60 (cf. FIG. 3).

The second freewheel 2 is located between a radially outer side of the freewheel carrier 6 and a part of the output shaft 4. The second freewheel 2 is a trapped roller freewheel. The second freewheel 2 automatically causes a torque transmission in the locking direction from the crankshaft 5 or the freewheel carrier 6 to the output shaft 4. In the open state, i.e., in the freewheeling direction, the second freewheel 2 automatically allows a free relative rotation of the output shaft 4 and the crankshaft 3 to each other.

In the drive assembly 10, the first freewheel 1 and the second freewheel 2 are arranged coaxially with one other and axially overlapping with respect to the axial direction of the crank axis 15. In addition, the bearing 7, which in particular forms one of the bottom brackets of the drive assembly 10, is arranged overlapping with the first freewheel 1 and the second freewheel 2 in the axial direction. In detail, a sectional plane 50 orthogonal to the crank axis 15 is defined, which intersects the first freewheel 1 and the second freewheel 2 and the bearing 7.

The drive assembly 10 thus offers the advantage of a particularly simple and compact design and geometry. In detail, the specific axial overlapping arrangement of freewheels 1,2 and the bearing 7 allows for a particularly small dimension of the overall drive assembly 10 in the axial direction. In this way, a particularly narrow drive assembly 10 can be provided, allowing the cranks 104 to be placed close to one other axially. In this way, optimum ergonomics and good riding comfort may be provided to the rider of the electric bicycle 100.

FIG. 4 shows a detailed sectional view of a drive assembly 10 according to a second exemplary embodiment of the disclosure. The second exemplary embodiment substantially corresponds to the first exemplary embodiment of FIGS. 1 to 3, with the difference being an alternative arrangement of the two freewheels 1, 2.

In the second exemplary embodiment, the arrangement of the two freewheels 1, 2 is swapped with respect to the radial direction. In detail, the first freewheel 1 is disposed radially within the second freewheel 2. This arrangement is made possible by alternative geometries of output element 3, output shaft 4 and freewheel carrier 6. In detail, these elements are configured such that the second freewheel 2 is arranged radially directly between a sub-area of the freewheel carrier 6 and a sub-area of the output shaft 4. In addition, the first freewheel 1 is disposed radially directly within a sub-area of the output element 3 and radially directly outside the output shaft 4.

The alternative arrangement of the freewheels 1, 2 according to the second exemplary embodiment provides the advantage that the second freewheel 2 configured as the rider freewheel has a larger diameter. In this way, a higher pedal torque can be transmitted via the second freewheel 2. For example, because the pedal torque may often be greater than the motor torque available from the motor 20, a particularly robust design of the drive assembly 10 may be provided in a straightforward and cost-effective manner.

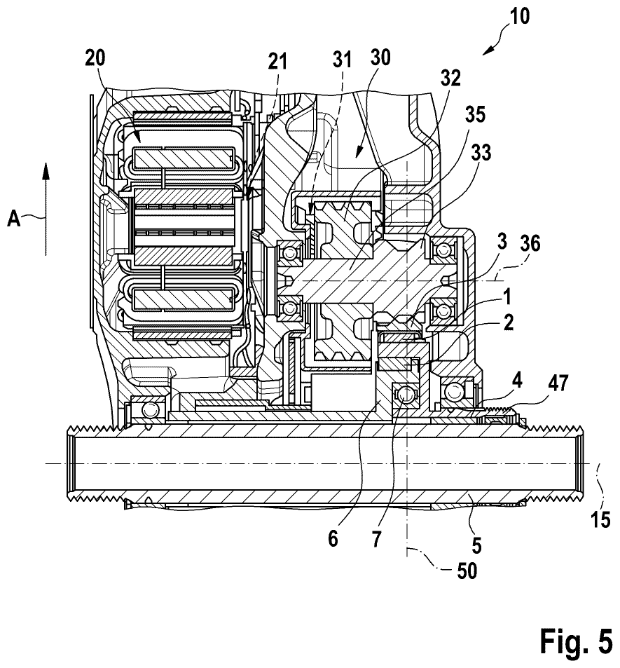

FIG. 5 shows a detailed sectional view of a drive assembly 10 according to a third exemplary embodiment of the disclosure. The third exemplary embodiment substantially corresponds to the first exemplary embodiment of FIGS. 1 to 3, with an alternative arrangement of the motor 20 and transmission 30.

In the third exemplary embodiment of FIG. 5, the motor 20 is arranged axially parallel to the crankshaft 5 and adjacent the crankshaft 5. For example, the motor 20 can be disposed upstream of the crankshaft 5 with respect to the direction of travel A (cf. FIGS. 1 and 5). In detail, the motor shaft 21 (not visible in FIG. 5 and hidden behind the sectional plane by other elements) is disposed at a predetermined distance from the crank axis 15. Accordingly, the motor keying 31 (also hidden and not visible in FIG. 5) is disposed parallel to and at a distance from the crank axis 15. The further configuration and function of the transmission 30 and the freewheels 1, 2 are substantially analogous to the first exemplary embodiment of FIGS. 1 to 3. An alternative geometry and arrangement of the components of the drive assembly 10 can thus be provided, which has a particularly compact geometry in the axial direction.

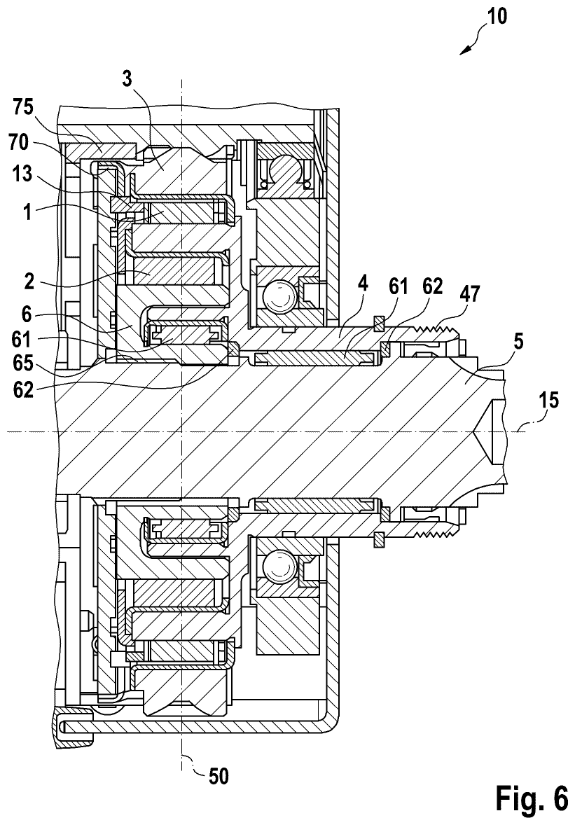

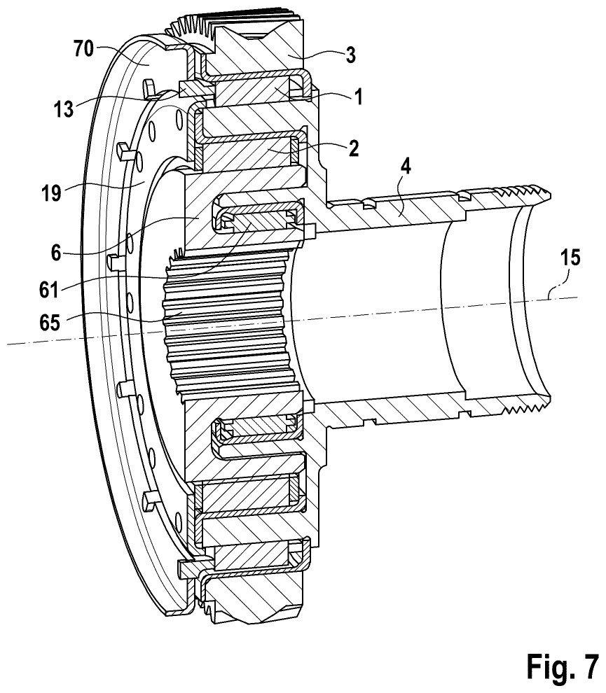

FIG. 6 shows a sectional view of a drive assembly 10 according to a fourth exemplary embodiment of the disclosure. FIG. 7 shows a perspective view of a detail of the drive assembly 10 of FIG. 6. The fourth exemplary embodiment substantially corresponds to the first exemplary embodiment of FIGS. 1 to 3, with the difference being an alternative support of the output shaft 4. In the fourth exemplary embodiment, the freewheel carrier 6 and the output shaft 4 are rotatably supported relative to one another by way of a needle bearing 61.

In particular, the freewheel carrier 6 has a substantially U-shaped cross section, wherein the needle bearing 61 and a bearing area of the output shaft 4 are disposed inside the partially enclosed opening of the freewheel carrier 6. A particularly compact design of the drive assembly 10, which also allows an optimum transmission of force of the components, can thus be provided.

Further, the drive assembly 10 of the fourth exemplary embodiment comprises a further needle bearing 61 between the crankshaft 5 and the output shaft 4, and further axial bearing elements 62. The axial bearing elements 62 are configured as thrust washers and can absorb axial forces. A first axial bearing element 62 is disposed between the freewheel cage 6 and output shaft 4, and a second axial bearing element 62 is disposed between the crankshaft 5 and output shaft 4.

In the fourth exemplary embodiment, there is further provided a spline 65 between the crankshaft 5 and freewheel carrier 6, which connects the crankshaft 5 and freewheel carrier 6 to one another in a rotationally fixed manner. The spline 65 allows a certain radial play, that is in particular a slight radial movement of the crankshaft 5 and the freewheel carrier 6 to each other.

FIG. 7 further shows a detailed view of the drive assembly 10 in the area of the freewheels 1, 2. The first freewheel 1 comprises a securing element 19, which is configured for axially securing the first freewheel 1.

In the fourth exemplary embodiment, the friction element 70, which is connected to the freewheel cage 6 in a rotationally fixed manner, is configured as an angled sheet, against which a plurality of spring elements distributed about the perimeters in the radial direction, which are arranged stationary on the immovable housing part 75, can push in order to generate a radial friction force (cf. FIG. 6).

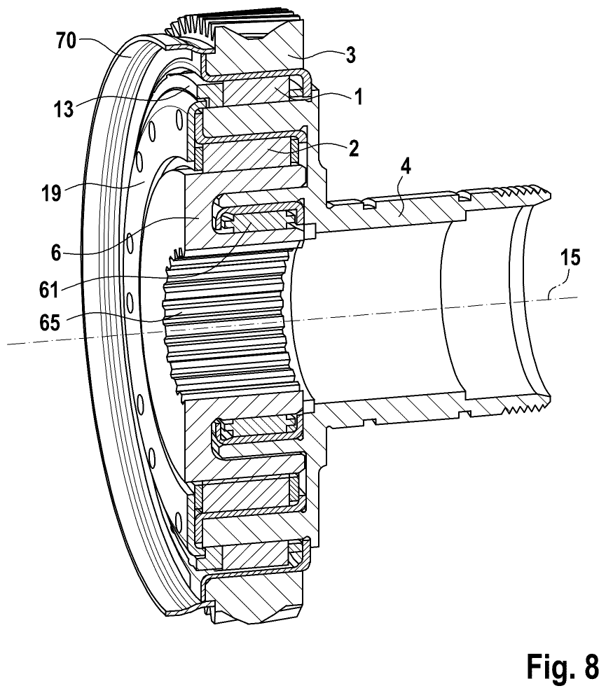

FIG. 8 shows a detail of a sectional view of a drive assembly 10 according to a fifth exemplary embodiment of the disclosure. The fifth exemplary embodiment substantially corresponds to the fourth exemplary embodiment of FIG. 7, with the difference of an alternative configuration of the friction element 70. In the fifth exemplary embodiment, the friction element 70 is directly connected in a rotationally fixedly manner to the output element 3. The friction element 70 can, for example, be configured as a substantially sleeve-shaped sheet. Analogously to the fourth exemplary embodiment, spring elements disposed on the immovable housing part push against the friction element 70 in the radial direction.

What is claimed is:

1. A drive assembly of an electric bicycle, comprising:
an output element which is configured to transmit a motor torque;
an output shaft;
a first freewheel; and
a second freewheel,
wherein the first freewheel and the second freewheel are disposed on the output shaft, and
wherein the first freewheel and the second freewheel are disposed coaxially and at least partially overlapping in the axial direction.

2. The drive assembly according to claim 1, wherein the second freewheel is a trapped roller freewheel.

3. The drive assembly according to claim 1, wherein the first freewheel is a bi-directional freewheel.

4. The drive assembly according to claim 3, wherein the first freewheel is configured to provide a bearing function in the freewheel direction.

5. The drive assembly according to claim 1, wherein:
the first freewheel is arranged between the output element and the output shaft, and
the first freewheel is configured as a motor freewheel to permit a torque transfer in the lock direction from the output element towards the output shaft.

6. The drive assembly according to claim 1, further comprising a crankshaft, wherein:
the second freewheel is disposed between the crankshaft and the output shaft, and
the second freewheel is configured as a rider's freewheel in order to permit torque transmission from the crankshaft towards the output shaft in the locking direction.

7. The drive assembly according to claim 6, further comprising a freewheel carrier connected to the crankshaft in a rotationally fixed manner.

8. The drive assembly according to claim 7, wherein the second freewheel is arranged between the freewheel carrier and the output shaft.

9. The drive assembly according to claim 7, wherein the freewheel carrier and the output shaft are rotatably supported relative to one another by way of a bearing.

10. The drive assembly according to claim 9, further comprising an axial bearing element arranged in the axial direction between the freewheel carrier and the output shaft.

11. The drive assembly according to claim 7, wherein the freewheel carrier is connected to the crankshaft by way of a spline.

12. The drive assembly according to claim 1, wherein the first freewheel is radially disposed within the second freewheel.

13. The drive assembly according to claim 1, wherein the second freewheel is disposed radially within the first freewheel.

14. The drive assembly according to claim 1, further comprising a bearing disposed coaxially with the first freewheel and the second freewheel and at least partially overlapping in the axial direction.

15. The drive assembly according to claim 1, further comprising:
a motor; and
a transmission,
wherein the transmission is disposed between the motor and the freewheels, and
wherein the output element is part of the transmission.

16. The drive assembly according to claim 15, wherein:
the motor comprises a motor shaft at which the motor torque is available, and
the motor shaft is disposed coaxially with the output shaft.

17. The drive assembly according to claim 16, wherein:
the motor comprises a motor shaft at which the motor torque is available, and t
he motor shaft is disposed parallel to the output shaft and at a predetermined distance from the output shaft.

18. An electric bicycle comprising a drive assembly according to claim 1.

19. The drive assembly according to claim 9, wherein the bearing is a needle bearing.
